(19) United States
(12) Patent Application Publication
(10) Pub. No.: US 2026/0160235 A1
(43) Pub. Date: Jun. 11, 2026

(54) DRIVETRAIN FOR WIND TURBINE AND WIND TURBINE

(71) Applicant: Envision Energy Co., Ltd., WUXI (CN)

(72) Inventors: Ralf Rueschoff, Dortmund (DE); Matthias Walkowiak, Dortmund (DE); Stephan Uhkoetter, Dortmund (DE); Manuel Joop, Dortmund (DE)

(73) Assignee: Envision Energy Co., Ltd., WUXI (CN)

(21) Appl. No.: 19/433,190

(22) Filed: Dec. 26, 2025

Related U.S. Application Data
(63) Continuation of application No. PCT/CN2023/109113, filed on Jul. 25, 2023.

(51) Int. Cl. F03D 80/70; F01M 1/02; F03D 9/25; F03D 15/10

(52) U.S. Cl. CPC F03D 80/707; F01M 1/02; F03D 9/25; F03D 15/101; F01M 2001/0215; F05B 2260/40311; F05B 2260/98

(57) ABSTRACT

The present invention relates to a drivetrain and a wind turbine with the drivetrain, where the drivetrain comprises at least a gearbox, a generator and a pump system for supplying lubrication medium to at least the gearbox or generator. The pump system comprises a plurality of pump units being mechanically connected to the planetary gear stage or the generator shaft. The mechanical connection can be a gear connection. The pump unit comprises a mechanical pump with a drive axle.

### CROSS-REFERENCE TO RELATED APPLICATIONS

This application is a continuation of International Application No. PCT/CN2023/109113, filed on Jul. 25, 2023, titled “A drivetrain for a wind turbine and a wind turbine”, the entire contents of which are incorporated herein by reference.

### FIELD OF THE INVENTION

The present invention relates to a drivetrain for a wind turbine, and the drivetrain comprises a gearbox, a generator and a pump system for circulating a lubrication medium within the drivetrain. The gearbox has a gearbox input configured to transfer torque to the gear stages and a gearbox output configured to be connected to a rotor of the generator. The generator has a stator arranged relative to the rotor, where the generator rotor is configured to rotate relative to the stator and to interact with the stator via at least one magnetic field. The pump system is connected to the gearbox and/or the generator and configured to supply the lubrication medium to the gearbox and/or the generator.

The present invention also comprises a wind turbine with the above drivetrain.

### BACKGROUND OF THE INVENTION

It is known that wind turbines over the recent years have increased in tower height and rotor diameter to capture more energy from the wind, thereby increasing the electrical power capacity of the wind turbine. Thereby also increasing the size and weight of the individual drivetrain components. As a result, the drivetrain components take up more space in the nacelle and require a more complex installation process.

One attempt to solve these problems is to integrate the generator with the gearbox to form a compact gearbox-generator arrangement. However, this compact gearbox-generator arrangement restricts the integration of a lubrication pump system. One way to solve this integration challenge is to increase the axial length of the gearbox, or to use a special custom-made pump. However, this increases the total costs, and the pump would not be replaceable or maintainable without having to disassemble the drivetrain.

CN 103047094 B discloses a lubrication system for a wind turbine drivetrain, comprising a separate gearbox output shaft arranged parallel to the axial direction of the input gear stage. The gearbox output shaft is connected to the rotor of a separate generator. The sun shaft of the first gear stage extends into a fixed planet carrier of the second gear stage. The sun shaft meshes with a larger cylindrical gear, which in turns meshes with the gearbox output shaft. The sun shaft further meshes with a mechanical pump arranged at the back-end cover via a gear connection. The mechanical pump interacts with an independent lubrication pump system, which uses an electrical pump for circulating lubrication oil through the gear mesh parts and the bearings.

Some gearbox-generator arrangements are connected to a fully electrical pump system that uses electrical pumps to supply lubrication oil to the gearbox-generator arrangement. However, this solution suffers from loss of oil pressure during external power cuts.

Therefore, a need for a drivetrain with an improved lubrication system and a wind turbine thereof is needed.

### OBJECT OF THE INVENTION

One object of the present invention is to solve the abovementioned problems of the prior art.

Another object of the present invention is to provide a drivetrain and a wind turbine that enable the integration of the pump into the gearbox-generator arrangement.

A further object of the present invention is to provide a drivetrain and a wind turbine that allows for maintenance or replacement of the pump without having to disassemble the drivetrain.

### DESCRIPTION OF THE INVENTION

One object of the present invention is achieved by a drivetrain for a wind turbine, comprising:
a gearbox with at least one gear stage, wherein the gearbox comprises at least a gearbox input configured to transfer torque to the at least one gear stage;
a generator with at least a rotor rotatably arranged relative to a stator, wherein the generator comprises at least a generator output configured to generate an output of the generator; and
a lubrication system arranged relative to the gearbox or the generator, wherein the lubrication system comprises at least one pump unit configured to supply a lubrication medium to at least the gearbox or generator, wherein
the lubrication system comprises at least one mechanical pump, and the at least one mechanical pump is connected to a shaft of the generator or to a planetary gear stage of the gearbox via a mechanical connection.

This provides a drivetrain with at least an alternative lubrication system compared to the prior art. The present lubrication system eliminates the need for increasing the axial length of the gearbox. Furthermore, the present lubrication system allows for an integration of the pump units into the drivetrain configuration.

The gearbox has a gearbox input for transferring torque into the gearbox and a gearbox output for transferring torque out of the gearbox. The gearbox may be a single-stage gearbox with only one gear stage, or a multi-stage gearbox with at least two gear stages. An input gear stage may be arranged relative to the gearbox input. An output gear stage may be arranged relative to the gearbox output. If the gearbox is a single-stage gearbox, the gear stage may form a combined input and output gear stage.

The gearbox and the generator may each comprise one or more bearings for supporting the respective rotatable components interacting with each other. The bearings may be roller bearings, slide bearings or a combination thereof. The lubrication system may be connected to one or both of the gearbox and the generator to supply a lubrication medium to the rotatable components. The lubrication medium may be oil, grease or another suitable lubrication medium.

The gearbox may comprise a cylindrical gear stage, a planetary gear stage, a helically gear stage or a combination thereof. The planetary gear stage may comprise at least a planet carrier, sun shafts and sun gears. Each gear stage may further comprise a gearbox housing part, where the gearbox housing parts together form the gearbox housing. This allows torque to be inputted at low speeds and outputted at medium or high speeds.

The generator may comprise at least a stator, a rotor and a generator housing. The stator may have a plurality of stator poles configured to interact with a plurality of rotor poles on the rotor via at least one magnetic field. The generator may further have a generator input for transferring torque into the generator and a generator output for providing an output of the generator. The generator output may be an electrical output, a mechanical output shaft, or a combination thereof.

The mechanical pump is a pump with a drive axle, where the drive axle has a mechanical connection to the gearbox or generator and is driven by the gearbox or generator. This allows for the integration of off-the-shelf mechanical pumps, thus eliminates need for expensive, custom-made pumps. This also allows for emergency lubrication during the power cut or erection phase, thereby reducing risk of gearbox failure and increasing operational temperature range compared to electrical pumps.

In one embodiment, the gearbox and the generator are interconnected by a co-axial connection.

The gearbox and the generator may be interconnected via a co-axial connection so that a pitch tube may extend through the gearbox-generator arrangement. Further, the main shaft may also be connected to the gearbox via another co-axial connection. The gearbox may have a main shaft end and an opposite generator end. The generator may have a gearbox end and an opposite power conversion end. The pitch tube may extend along the entire axial length from the main shaft end to the power conversion end. Alternatively, the pitch tube may terminate within the generator housing, i.e., between the gearbox end and the power conversion end.

The gearbox output may be connected directly to the generator input. The gearbox output may be a sun shaft of a gear stage. The generator input may be a connecting flange of the rotor structure of the generator. The generator input may also be a bearing cartridge, a rotor shaft or an intermediate shaft connected to the rotor structure. This provides a firm connection for transferring torque from the gearbox to the generator.

The present invention allows the gearbox and the generator rotor to rotate around the same rotation axis. Whereas in conventional drivetrains, the gearbox has a separate output shaft with a rotation axis arranged parallel to the rotation axis of the gearbox input shaft or flange.

In one embodiment, the gearbox and the generator are interconnected by an intermediate shaft or a rotor shaft.

The gearbox output, such as the sun shaft, may be indirectly connected to the generator input, such as the rotor structure. The generator input may also comprise a bearing cartridge, a rotor shaft or an intermediate shaft connected to the rotor structure. The intermediate shaft may be connected to the sun shaft at one end, e.g., via a shaft connection. The intermediate shaft may be connected to the rotor structure of the generator at the other end, e.g., via the flange connection. This provides a firm connection for transferring torque from the gearbox to the generator.

In one embodiment, the gearbox and the generator form an integrated gearbox-generator arrangement.

The present invention allows for the integration of the gearbox and the generator to form a compact gearbox-generator arrangement. In this compact gearbox-generator arrangement, a shared bearing arrangement may be provided between the gearbox and the generator.

The main shaft and the gearbox may be integrated to form a compact main shaft-gearbox arrangement. In this compact main shaft-gearbox arrangement, another shared bearing arrangement may be provided between the main shaft and the gearbox.

Optionally, the main shaft, the gearbox and the generator may be integrated to form a compact drivetrain arrangement. The weight of the gearbox and generator may be supported by the shared bearings and loads may be transferred to the mainframe via the main bearing arrangement.

In one embodiment, the lubrication system further comprises at least one electrical pump, and a local motor is configured for driving the electrical pump.

The electrical pump is a pump with a drive axle, wherein the pump is driven by a local motor. The electrical pump may be operated by a control unit, such as the wind turbine controller. The electrical pump has a faster reaction time compared to mechanical pumps and allows the oil pressure to be adapted to operation of the wind turbine.

The present lubrication system may comprise a combination of mechanical and electrical pumps, which can be used together with an integrated gearbox-generator arrangement. This provides emergency lubrication during the power cut and allows the oil pressure to be adapted to the operation of the wind turbine.

In one embodiment, the planetary gear stage is an output gear stage.

The present invention allows the pump units, such as the mechanical pumps, to be driven by at least the output gear stage of the gearbox. The pump units may be arranged on the exterior of the gearbox housing, where the individual drive axles may extend into the interior of the gearbox. This allows for easy access during replacement or maintenance.

In one embodiment, the at least one pump unit is mechanically connected to a planet carrier of the planetary gear stage.

The present invention further allows the pump units, such as the mechanical pumps, to be driven by the outputting sun shaft of the gearbox. The sun shaft may rotate at medium speeds. The speed and dimensions of this gear stage allows for optimal connection to the pump units.

In one embodiment, the at least one pump unit comprises a drive axle connected to the pump, where the drive axle extending in an angled direction relative to an axial direction of the gearbox.

The drive axle and pump may be positioned relative to the axial direction of the gearbox, such as the sun shaft, or the generator, such as the intermediate shaft or generator rotor. For example, the drive axle may extend in an angled direction relative to an axial direction of the gearbox or generator. For example, the angular position may be a sloping angle relative to the axial direction. The placement and orientation of the respective pump units may thus be adapted to the gearbox-generator configuration.

In one embodiment, the at least one pump unit comprises a drive axle connected to the pump, where the drive axle extending in a radial direction to an axial direction of the gearbox.

Alternatively, the drive axle may extend in a radial direction relative to the axial direction of the gearbox or generator. For example, the radial position may be perpendicular to the axial direction. The placement and orientation of the respective pump units may thus be adapted to the gearbox-generator configuration.

In one embodiment, the at least one pump unit comprises a drive axle connected to the pump, where the drive axle extending in a second axial direction relative to an axial direction of the gearbox.

Alternatively, the drive axle may extend in a second, parallel axial direction relative to the axial direction of the gearbox or generator. The placement and orientation of the respective pump units may thus be adapted to the gearbox-generator configuration.

In one embodiment, the mechanical connection is a gear connection.

The mechanical connection between the drive axle and the sun shaft, intermediate shaft or rotor shaft may be a gear connection. This allows for upscaling of the rotational speed of the drive axle. The gear ratio may thus be adapted to control the operation of the mechanical pump.

In one embodiment, the gear connection being a bevel gear, a crown gear, a beveloid gear or a spiroplan gear.

The gear connection may be adapted to the configuration between the gearbox output and the generator input. The interacting gear elements may be adapted to the relative orientation between the drive axle of the pump unit and the sun shaft, intermediate shaft or rotor shaft.

In one embodiment, the gear connection comprises a crown gear, and the crown gear is arranged on the planet carrier or the drive axle.

This gear configuration provides a reliable coupling between the drive axle and the planetary gear stage.

In one embodiment, the least one pump unit is connected to a rotor shaft of the generator, and the mechanical connection is arranged at a front end or a rear end of the generator or between the front and rear ends of the generator.

The pump unit, such as the electrical pump, may be arranged relative to the generator housing. For example, the pump may be arranged on the back end or on the exterior side of the generator housing. The drive axle may be connected to the generator rotor, such as the intermediate shaft or rotor shaft, via a mechanical connection arranged at the front end or at the back end, or between the front and rear ends.

In one embodiment, the at least one pump unit is a constant displacement pump.

The present invention allows for the use of a cheap and reliable pump, such as a constant displacement pump. The pump may be selected to supply lubrication medium, e.g., lubrication oil, to the drivetrain.

In one embodiment, the lubrication system comprises a plurality of pump units being distributed around a circumference of the gearbox or the generator.

The lubrication system may comprise multiple pump units distributed around the circumference of the gearbox or generator housing. The number of pump units may be selected based on the gearbox-generator configuration. This allows for use of individual smaller pumps units compared to a single, common pump unit. The number of pump units may be at least two, preferably between two and ten.

The lubrication system may comprise a first pump unit and at least a second pump unit, wherein the first and second pump units may have different configurations. Alternatively, all the pump units may have the same configuration. The first pump unit and/or second pump unit may be a bidirectional or a unidirectional pump, or a combination of bidirectional and unidirectional pumps.

The first pump unit and/or second pump unit may be a mechanical pump or an electrical pump, or a combination of mechanical and electrical pumps.

One object of the present invention is achieved by a wind turbine, wherein the wind turbine comprises a wind turbine tower, a nacelle arranged on top of the wind turbine tower, and a rotor comprising a hub and at least one wind turbine blade, and the rotor is arranged relative to the nacelle and mechanically connected to a drivetrain of the wind turbine, wherein the drivetrain is configured as described above.

This provides a wind turbine comprising a lubrication system integrated in the drivetrain. The drivetrain comprises a gearbox with an integrated generator. Preferably, the main shaft, gearbox and generator may be integrated to form a compact drivetrain. This eliminates the need for expending the axial length of the drivetrain. Also, the present invention allows for the use of off-the-shelf pumps and eliminates the need for expensive, custom-made pumps.

### DESCRIPTION OF THE DRAWING

The present invention is described by example only and with reference to the drawings, wherein:

FIG. 1 shows an exemplary embodiment of a wind turbine,

FIG. 2 shows an exemplary embodiment of a drivetrain of the wind turbine,

FIG. 3 shows a first embodiment of the drivetrain with an integrated pump unit,

FIG. 4 shows a close-up of the pump unit and gear connection of FIG. 3,

FIG. 5 shows a second embodiment of the drivetrain with an integrated pump unit,

FIG. 6 shows a close-up of the pump unit and gear connection of FIG. 5,

FIG. 7 shows a third embodiment of the drivetrain with an integrated pump unit,

FIG. 8 shows a close-up of the pump unit and gear connection of FIG. 7,

FIG. 9 shows a fourth embodiment of the drivetrain with an integrated pump unit,

FIG. 10 shows a close-up of the pump unit and gear connection of FIG. 9,

FIG. 11 shows a fifth embodiment of the drivetrain with an integrated pump unit, and

FIG. 12 shows a close-up of the pump unit and gear connection of FIG. 11.

In the following text, the figures will be described one by one, and the different parts and positions seen in the figures will be numbered with the same numbers in the different figures. Not all parts and positions indicated in a specific figure will necessarily be discussed together with that figure.

### DETAILED DESCRIPTION OF THE INVENTION

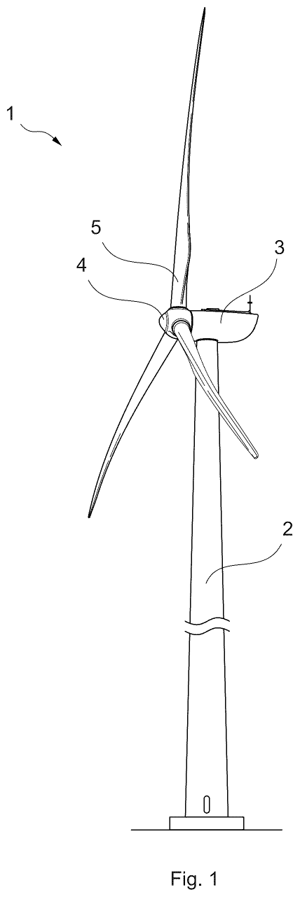

FIG. 1 shows an exemplary embodiment of a wind turbine 1 comprising a wind turbine tower 2, a nacelle 3 arranged on top of the wind turbine tower 2, and a rotor connected to a drivetrain in the nacelle 3. The rotor comprises a hub 4 and at least one wind turbine blade 5 connected to the hub 4. Here, three wind turbine blades 5 are shown, but the hub 5 may be connected to two, four or more wind turbine blades.

The wind turbine 1 is here shown as an onshore wind turbine, but the wind turbine 1 may also be an offshore wind turbine 1.

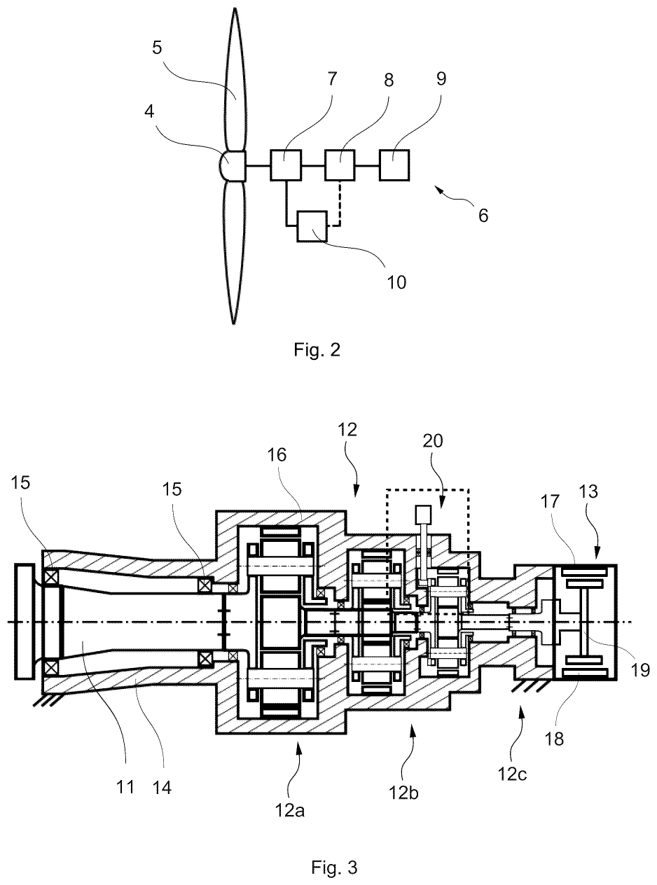

FIG. 2 shows an exemplary embodiment of a drivetrain 6 of the wind turbine 1, where the rotor is mechanically connected to an input interface of a gearbox 7 for transferring torque to the gear stage(s) of the gearbox 7. Optionally, the hub 4 may be connected directly to the gearbox input via a bolted connection or a shaft connection.

An output interface of the gearbox 7 is mechanically connected to a rotor of a generator 8. The generator 8 further comprises a stator arranged relative to the rotor, each of which comprises a plurality of pole units configured to interact with each other via at least one magnetic field. Rotation of the generator rotor relative to the generator stator generates an electrical output current in the generator 8.

The electrical output of the generator 8 is connected to power conversion components 9, which are configured to transform the electrical power output of the generator 8 into a power output suitable for an electrical grid. Optionally, the generator 8 may have an output shaft for providing a mechanical output.

A lubrication system 10 is further connected to at least the gearbox 7, optionally also to the generator 8 as illustrated by the dotted line. The lubrication system 10 comprises at least one pump unit configured to supply a lubrication medium, such as oil, to the gearbox 7 and optionally the generator 8 for cooling the rotatable components and reduce wear on the rotating components.

Here, the gearbox 7 and the generator 8 are interconnected by a medium speed shaft. However, the gearbox 7 and the generator 8 may also be integrated to a form a compact gearbox-generator arrangement.

FIG. 3 shows a first embodiment of the drivetrain 6 with an integrated pump unit. Here, the drivetrain 6 comprises a main shaft 11 with an integrated gearbox 12 and generator 13. The main shaft 11 has a rotor end and an opposite gearbox end. The main shaft 11 is arranged in a main bearing housing 14, where a main bearing arrangement 15 is arranged at the rotor end and the gearbox end, respectively.

The gearbox 12 comprises multiple gear stages 12a, 12b, 12c in the form of planetary gear stages. The main shaft 11 is connected to a first planet carrier of an input gear stage 12a via a mechanical connection. The gear stages 12a, 12b, 12c are arranged in a gearbox housing 16, which is fixedly connected to the main bearing housing 14.

The generator 13 comprises a stator 18 and a rotor 19 arranged rotatable relative to each other. The stator 18 and rotor 19 are arranged in a generator housing 17, which is fixedly connected to the gearbox housing 16. The rotor 19 is connected to the output of the last gear stage 12c.

The lubrication system 10 comprises a number of pump units 20 distributed around the circumference of the gearbox housing 16. Here, the pump unit 20 extend into the gearbox housing 16 and is mechanically connected to the last gear stage 12c via an axial gear connection.

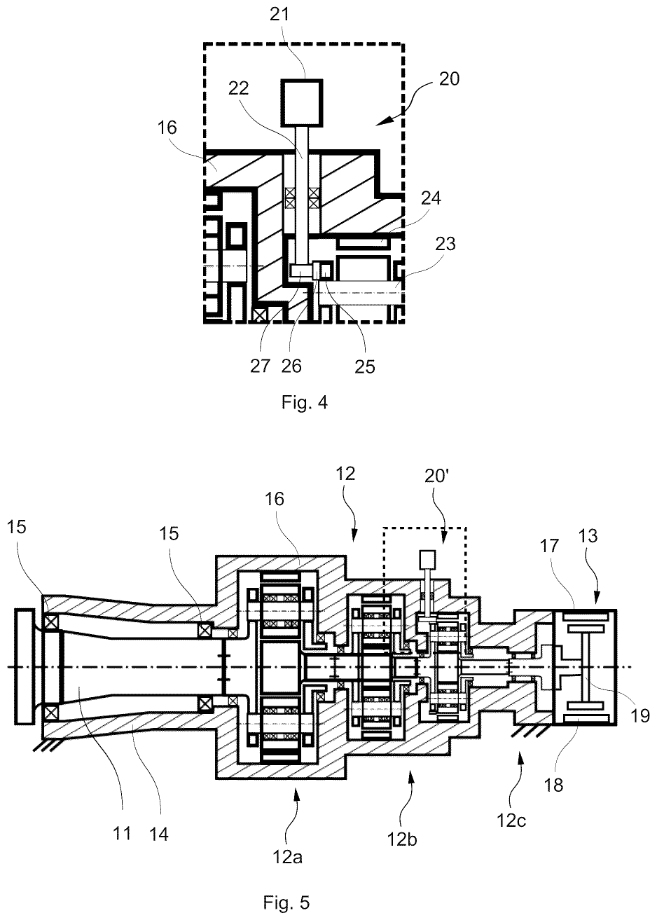

FIG. 4 shows a close-up of the pump unit 20 and the axial gear connection arranged between the drive axle 22 of the pump 21 and the planet carrier 25 of the last gear stage 12c. The last gear stage 12c further comprises at least one sun pin 23 and at least one sun gear 24.

The drive axle 22 extends through the gearbox housing 16 and is connected to a first gear element 27. The first gear element 27 interacts with a second gear element 26 arranged on the planet carrier 25. Here, the first gear element 27 is shaped as a gear pinion. Here, the second gear element 26 is shaped as a crown gear extending the circumference of the planet carrier 25.

FIG. 5 shows a second embodiment of the drivetrain 6 with an integrated pump unit 20′. The pump unit 20′ extend into the gearbox housing 16 and is mechanically connected to the last gear stage 12c via a radial connection.

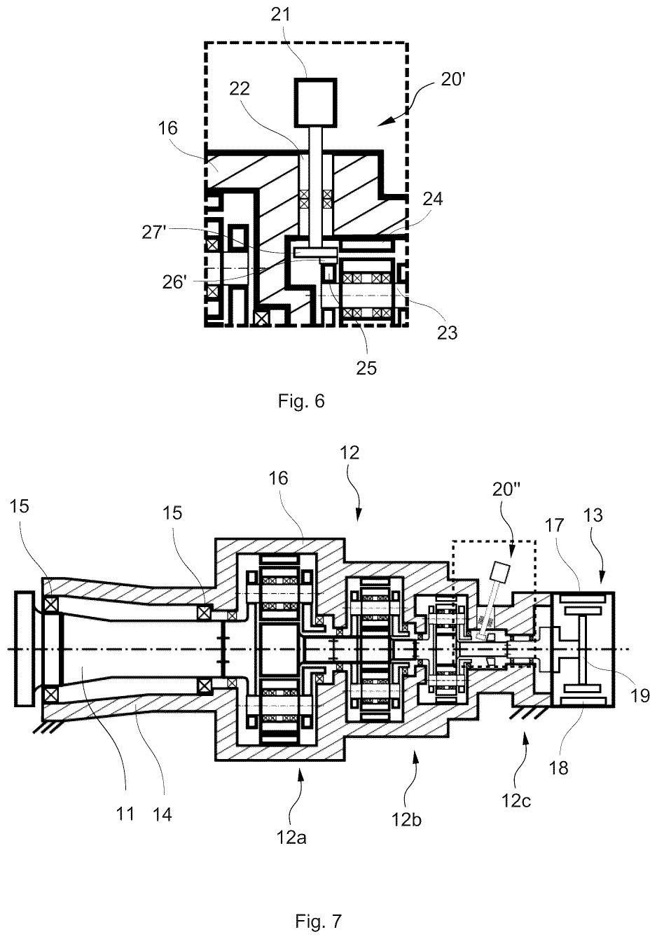

FIG. 6 shows a close-up of the pump unit 20′ and the radial gear connection arranged between the drive axle 22 of the pump 21 and the planet carrier 25 of the last gear stage 12c. Here, the pump 21 and the drive axle 22 extend radially relative to the axial direction (indicated by dotted line) of the gear stage.

The first gear element 27 interacts with the second gear element 26 arranged on the planet carrier 25. Here, the first gear element 27 is shaped as an alternative crown gear. Here, the second gear element 26 is shaped as a gear wheel extending the circumference of the planet carrier 25.

FIG. 7 shows a third embodiment of the drivetrain 6 with an integrated pump unit 20″. The pump unit 20″ extend into the gearbox housing 16 and is mechanically connected to the last gear stage 12c via an angled gear connection.

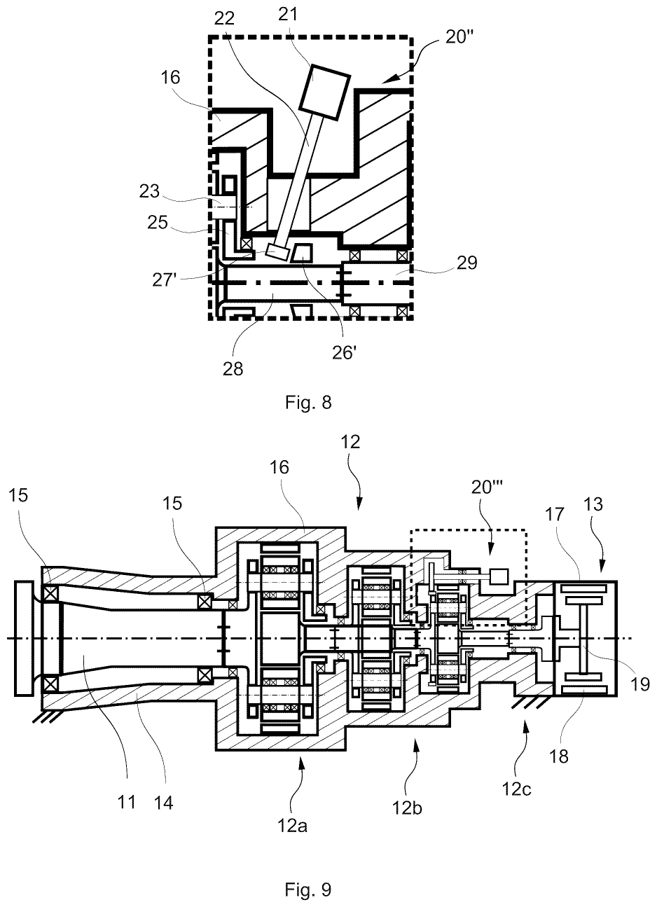

FIG. 8 shows a close-up of the pump unit 20″ and the angled gear connection arranged between the drive axle 22 of the pump 21 and the planet carrier 25 of the last gear stage 12c. Here, the pump 21 and the drive axle 22 extend in a sloping direction relative to the axial direction (indicated by dotted line) of the gear stage.

The first gear element 27′ interacts with the second gear element 26′ arranged on an outputting sun shaft 28. Here, the first gear element 27′ is shaped as a gear pinion. Here, the second gear element 26′ extends the circumference of the sun shaft 28.

FIG. 9 shows a fourth embodiment of the drivetrain 6 with an integrated pump unit 20′″. The pump unit 20′″ extend into the gearbox housing 16 and is mechanically connected to the last gear stage 12c via an alternative radial gear connection.

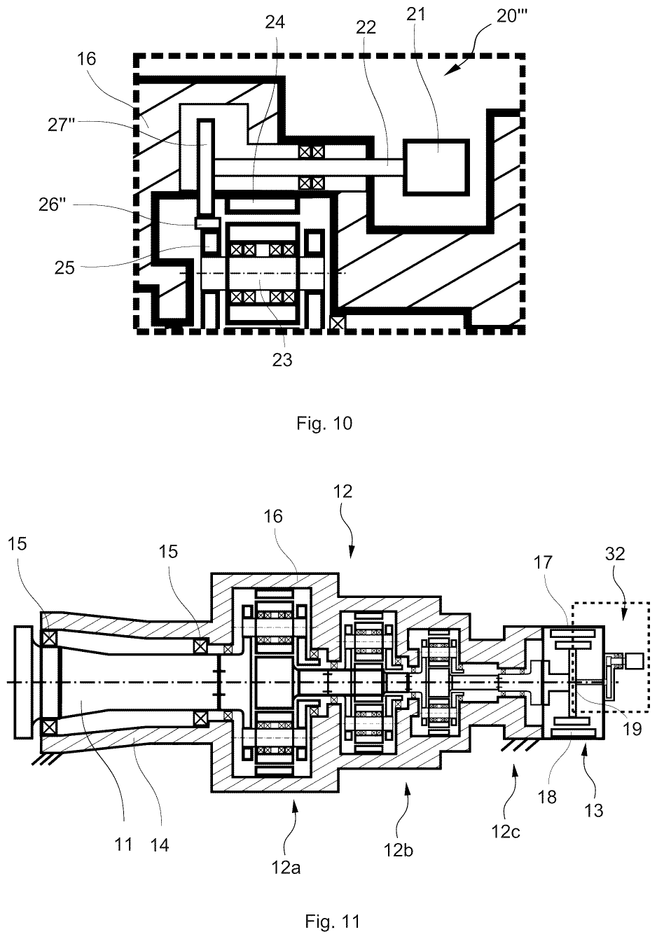

FIG. 10 shows a close-up of the pump unit 20′″ and the alternative radial gear connection arranged between the drive axle 22 of the pump 21 and the planet carrier 25 of the last gear stage 12c. Here, the pump 21 and the drive axle 22 extend in a second axial direction arranged parallel to the axial direction (indicated by dotted line) of the gear stage.

The first gear element 27″ interacts with the second gear element 26″ arranged on the planet carrier 25. Here, the first gear element 27″ is shaped as a gear pinion. Here, the second gear element 26″ is shaped as a gear wheel or spur gear extending the circumference of the planet carrier 25.

FIG. 11 shows a fifth embodiment of the drivetrain 6 with an integrated pump unit 32. The pump unit 32 is arranged at the back end of the generator 13 and is mechanically connected to the rotor 19 via a mechanical connection.

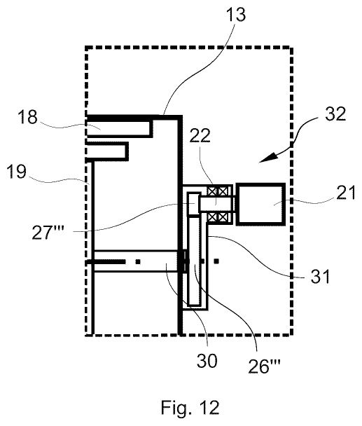

FIG. 12 shows a close-up of the pump unit 32 and the mechanical connection arranged between the drive axle 22 of the pump 21 and rotor 19 of the generator 13.

The first gear element 27′″ interacts with the second gear element 26′″ arranged on a rotor shaft 30 of the rotor 19. Alternatively, the first gear element 27′″ may be arranged on a connecting flange of the rotor 19. Here, the first gear element 27′″ is shaped as a gear pinion. Here, the second gear element 26′″ is shaped as a gear wheel.

1. A drivetrain (6) for a wind turbine (1), comprising:
a gearbox (7) with at least one gear stage (12a, 12b, 12c), wherein the gearbox (7) comprises at least a gearbox input configured to transfer torque to the at least one gear stage;
a generator (8) with at least a rotor (19) rotatably arranged relative to a stator (18), wherein the generator (8) comprises at least a generator output configured to generate an output of the generator (8); and
a lubrication system (10) arranged relative to the gearbox (7) or the generator (8), wherein the lubrication system (10) comprises at least one pump unit (20) configured to supply a lubrication medium to at least the gearbox (7) or generator (8), wherein
the lubrication system (10) comprises at least one mechanical pump, the at least one mechanical pump is connected to a shaft of the generator (8) or to a planetary gear stage of the gearbox (7) via a mechanical connection.

2. The drivetrain according to claim 1, wherein the gearbox (7) and the generator (8) are interconnected by a co-axial connection.

3. The drivetrain according to claim 2, wherein the gearbox (7) and the generator (8) are interconnected by an intermediate shaft (29) or a rotor shaft.

4. The drivetrain according to claim 1, wherein the gearbox (7) and the generator (8) form an integrated gearbox-generator arrangement.

5. The drivetrain according to claim 1, wherein the lubrication system (10) further comprises at least one electrical pump, and a local motor is configured for driving the electrical pump.

6. The drivetrain according to claim 1, wherein the planetary gear stage is an output gear stage (12c).

7. The drivetrain according to claim 1, wherein the at least one pump unit (20) is mechanically connected to a planet carrier (25) of the planetary gear stage.

8. The drivetrain according to claim 1, wherein the at least one pump unit (20) comprises a drive axle (22) connected to the pump (21), where the drive axle (22) extending in an angled direction relative to an axial direction of the gearbox (7).

9. The drivetrain according to claim 1, wherein the at least one pump unit (20) comprises a drive axle (22) connected to the pump (21), where the drive axle (22) extending in a radial direction to an axial direction of the gearbox (7).

10. The drivetrain according to claim 1, wherein the at least one pump unit (20) comprises a drive axle (22) connected to the pump (21), where the drive axle (22) extending in a second axial direction relative to an axial direction of the gearbox (7).

11. The drivetrain according to claim 1, wherein the mechanical connection is a gear connection.

12. The drivetrain according to claim 11, wherein the gear connection being a bevel gear, a crown gear, a beveloid gear or a spiroplan gear.

13. The drivetrain according to claim 11, wherein the gear connection comprising a crown gear, and the crown gear being arranged on the planet carrier (25) or the drive axle (22).

14. The drivetrain according to claim 1, wherein the least one pump unit (20) is connected to a rotor shaft (29) of the generator (8), and the mechanical connection is arranged at a front end or a rear end of the generator (8) or between the front and rear ends of the generator (8).

15. The drivetrain according to claim 1, wherein the at least one pump unit (20) is a constant displacement pump.

16. The drivetrain according to claim 1, wherein the lubrication system (10) comprises a plurality of pump units (20) being distributed around a circumference of the gearbox (7) or the generator (8).

17. A wind turbine (1) comprising a wind turbine tower (2), a nacelle (3) arranged on top of the wind turbine tower (2), and a rotor comprising a hub (4) and at least one wind turbine blade (5), wherein the rotor is arranged relative to the nacelle (3) and mechanically connected a drivetrain (6) of the wind turbine (1), wherein the drivetrain (6) comprises:
a gearbox (7) with at least one gear stage (12a, 12b, 12c), wherein the gearbox (7) comprises at least a gearbox input configured to transfer torque to the at least one gear stage;
a generator (8) with at least a rotor (19) rotatably arranged relative to a stator (18), wherein the generator (8) comprises at least a generator output configured to generate an output of the generator (8); and
a lubrication system (10) arranged relative to the gearbox (7) or the generator (8), wherein the lubrication system (10) comprises at least one pump unit (20) configured to supply a lubrication medium to at least the gearbox (7) or generator (8), wherein the lubrication system (10) comprises at least one mechanical pump, and the at least one mechanical pump is connected to a shaft of the generator (8) or to a planetary gear stage of the gearbox (7) via a mechanical connection.
